(19) United States
(12) Patent Application Publication
(10) Pub. No.: US 2019/0270512 A1
(43) Pub. Date: Sep. 5, 2019

(54) LEG UNDERCARRIAGE SYSTEM FOR JUMPING AIRCRAFT

(71) Applicant: Passerine Aircraft Corporation, San Francisco, CA (US)

(72) Inventor: Matthew Whalley, Johannesburg (ZA)

(21) Appl. No.: 16/291,613

(22) Filed: Mar. 4, 2019

Related U.S. Application Data
(60) Provisional application No. 62/638,114, filed on Mar. 3, 2018.

(51) Int. Cl. B64C 25/00

(52) U.S. Cl. CPC B64C 25/001; B64C 2025/008

(57) ABSTRACT

Methods and systems are provided to allow a traditional fixed wing aircraft to perform standing takeoffs and spot landings. Methods and systems relate to a leg undercarriage system that allow an aircraft to take off from a stationary position and to make a spot landing. Methods and systems include an attachment to an aircraft fuselage and one or more leg links and a foot in contact with the ground, a power spring to store energy for propelling the aircraft, a quick release hook to hold the leg undercarriage in a prelaunch position, and an actuation source to move the aircraft to a position that triggers the quick release hook to release and cause the power spring to release its energy and quickly transition the leg undercarriage system to a fully extended state, thus imparting velocity and altitude to the aircraft. Methods and systems relate to a retraction spring for retracting the leg undercarriage system to a flight position and an electrical servo for retracting the leg undercarriage system to a flight position.

### CROSS-REFERENCE TO RELATED APPLICATIONS

This application claims the benefit of U.S. Provisional Patent Application No. 62/638,114 filed Mar. 3, 2018, which is/are all hereby incorporated by reference in their entirety.

### FIELD OF THE INVENTION

The present invention relates to a leg undercarriage system for propelling an aircraft into the air.

### BACKGROUND

Traditional fixed wing aircraft take off by accelerating and rolling on a runway and nosing up for takeoff. The requirement of a runway for takeoff and landing limits the situations in which fixed wing aircraft can operate. They cannot perform standing takeoffs or spot landings.

Rotor aircraft such as helicopters can take off without specific takeoff or landing infrastructure. However, they have several disadvantages as compared to fixed wing aircraft such as less endurance, lower flight speed, shorter range, and less scalability.

It would be desirable to develop mechanisms for a traditional fixed wing aircraft to perform standing takeoffs and spot landings. Such a mechanism would enable the aircraft to benefit from the advantages of fixed wing aircraft and multirotor aircraft alike.

### SUMMARY OF THE INVENTION

Embodiments of the invention relate to a leg undercarriage system that allows an aircraft to take off from a stationary position. Some embodiments may also relate to a leg undercarriage system that allows an aircraft to make a spot landing.

Embodiments of the invention may include an attachment to an aircraft fuselage and one or more leg links and a foot in contact with the ground. A power spring may store energy for propelling the aircraft. A quick release hook may hold the leg undercarriage in a prelaunch position. An actuation source may move the aircraft to a position that triggers the quick release hook to release and cause the power spring to release its energy and quickly transition the leg undercarriage system to a fully extended state. This may impart velocity and altitude to the aircraft.

Embodiments may also relate to a retraction spring for retracting the leg undercarriage system to a flight position. Embodiments may relate to an electrical servo for retracting the leg undercarriage system to a flight position.

Embodiments may also relate to tensioning the power spring during flight to extend the leg undercarriage into a landing position where the leg acts as a shock absorber.

### BRIEF DESCRIPTION OF THE DRAWINGS

FIG. 1 is a perspective view of one leg of an embodiment of a leg undercarriage system.

FIG. 2 is a side view of the one leg of the embodiment of the leg undercarriage system illustrating its components.

FIGS. 3A-E illustrate five states of a leg undercarriage system.

FIG. 4 is a flow chart illustrating an exemplary method for transitioning between the five states of the leg undercarriage system.

FIG. 5 is a top perspective view of the embodiment of the leg undercarriage system in a prelaunch position.

FIG. 6 is a side view of the embodiment of the leg undercarriage system in a prelaunch position.

FIG. 7 is a front view of the embodiment of the leg undercarriage system in a prelaunch position.

FIG. 8 is a back view of the embodiment of the leg undercarriage system in a prelaunch position.

FIG. 9 is a front view of the embodiment of the leg undercarriage system in a fully extended state.

FIG. 10 is a back view of the embodiment of the leg undercarriage system in a fully extended state.

FIG. 11 shows the leg undercarriage with two legs fitted to a fixed wing aircraft.

### DETAILED DESCRIPTION

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

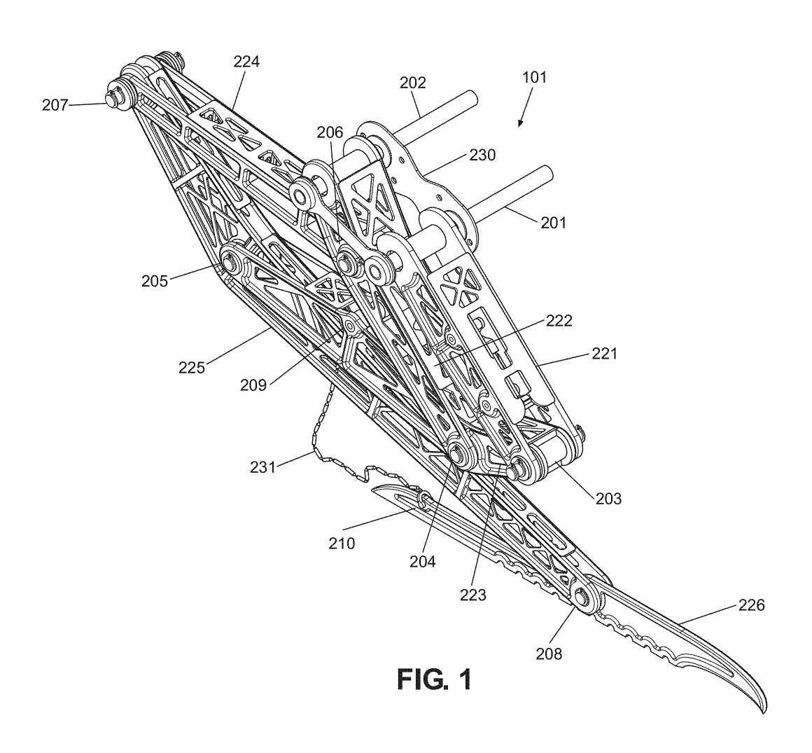

FIG. 1 is perspective view of one leg 101 of a leg undercarriage system 1101 that is a landing gear for an aircraft. The leg undercarriage system may include two legs, one port and one starboard. The two legs may be mirror images with the same structure and components. The leg undercarriage system may be attached to the bottom of the fuselage of a fixed wing aircraft. It provides the function of launching the aircraft into the air from a stationary position. Moreover, the leg undercarriage system may be expanded or retracted through at least five states. One state may be a prelaunch position. A second state may initiate launch by the leg undercarriage system. A third state may be full extension of the leg undercarriage system. A fourth state may be a flight position. A fifth state may be suitable for making a spot landing.

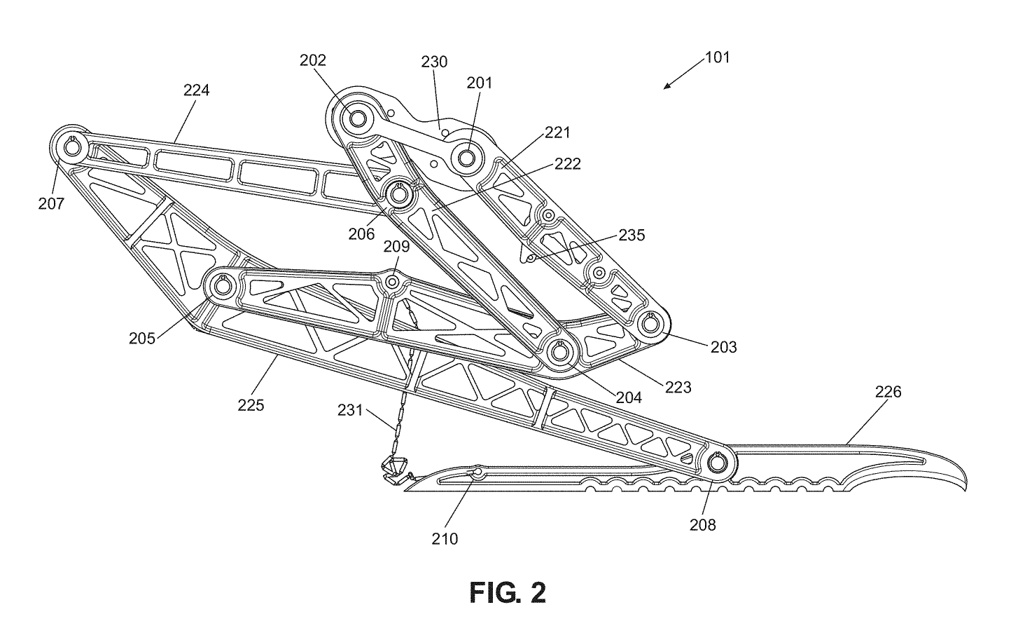

FIG. 2 is a side view of one leg 101 of the leg undercarriage system 1101 illustrating its components. As described above, the leg undercarriage system may comprise two legs that have the same structure and components. Each leg of the leg undercarriage system comprises multiple leg links, which are hereafter referred to as links. Each leg comprises a fuselage attachment 230 that connects to an aircraft body 1102. The fuselage attachment 230 is connected by pin 1, 201 to link 1, 221. The fuselage attachment is connected by pin 2, 202 to link 2, 222. Link 1, 221 and link 2, 222 are connected by pins 3 and 4, 203 204, respectively, to link 3, 223. Link 2, 222 is connected by pin 6, 206 to link 4, 224. Link 4, 224 is connected by pin 7, 207 to link 5, 225. Link 3, 223 is connected by pin 5, 205 to link 5, 225. Link 5, 225 is connected by pin 8, 208 with link 6, 226. A quick release hook 235 latches on to pin 8, 208 of link 5, 225 from link 1, 221 to keep the upper leg structure locked until the aircraft is in the correct orientation for launch. A pull rod attachment moves the quick release hook to release from pin 8, 208 when the aircraft reaches the correct orientation. The pull rod attachment may be a mechanical linkage to link 6, 226 for performing this function. Alternatively, an electrical servo attached to the leg undercarriage system may be used to move the quick release hook to release from pin 8, 208 when the aircraft reaches the correct orientation.

The fuselage attachment distributes loads into the fuselage of the aircraft. Link 1, 221 is a first link in a first (upper) stage of the leg. It transfers loads into the fuselage attachment and holds the quick release hook. Link 2, 222 is a second link in a first (upper) stage of the leg. It also transfers loads into the fuselage attachment. Link 3, 223 is the larger and longer of two links in the second (lower) stage of the leg. Link 4, 224 is the smaller and shorter of two links in the second (lower) stage of the leg. Link 5, 225 transfers loads between links 3 and 4, 223 224 and link 6, 226. Link 6, 226 may be referred to as a toe and is the final link in the leg mechanism. It is designed to grip the ground and prevent slippage.

Ten pins are shown in FIG. 2 that join the links together. Pins and bushings are used to minimize friction. Other mechanisms of attachment may be made between links, such that the links may rotate around their points of connection. The points of connection may be referred to as joints.

A tension member connects pin 9, 209 to pin 10, 210 and is a flexible tension link 231 such as a string, wire, or the like. The tension member exerts only a tension force.

A power spring stores energy for propelling the aircraft with a jump motion. The spring may be mechanical, such as an elastic member, or air powered, such as a pneumatic cylinder. The spring is located between pins 2, 3, and 7, 202 203 207. Pin 2, 202 contains a spool for tensioning and relaxing the spring.

A retract spring can be located between pins 9, 209 and 8, 208 and exerts a force to retract the leg undercarriage from the fully extended position to a flight (retracted) position. It stores significantly less energy than the power spring. Alternatively, an electrical servo may be attached to the leg and retract the leg undercarriage from the fully extended position to a flight (retracted position).

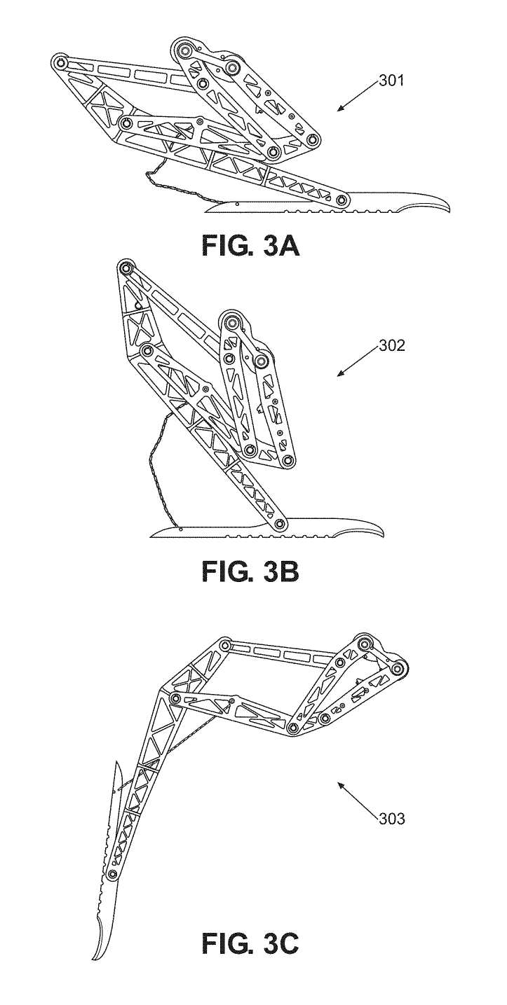

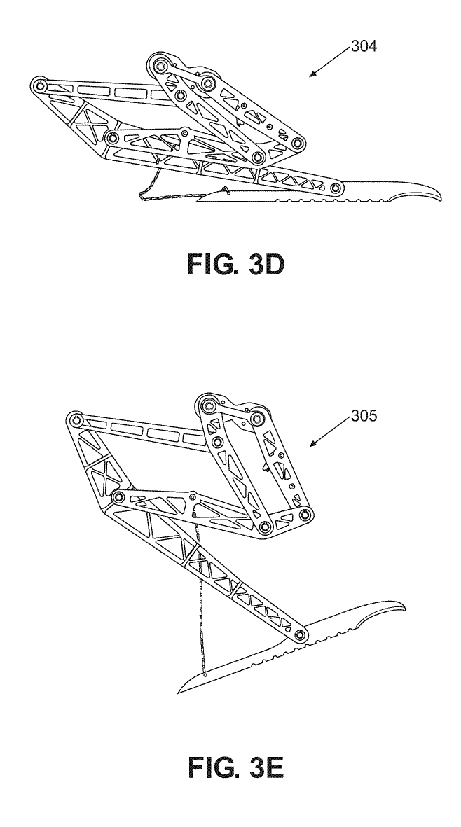

FIGS. 3A-E illustrate the five states of the leg undercarriage system as it transitions from prelaunch to launch to flight to landing. The five states include FIG. 3A an initial (prelaunch) position 301, FIG. 3B a trigger disengage position 302, FIG. 3C a full extension position 303, FIG. 3D a flight position 304, and FIG. 3E a landing position 305.

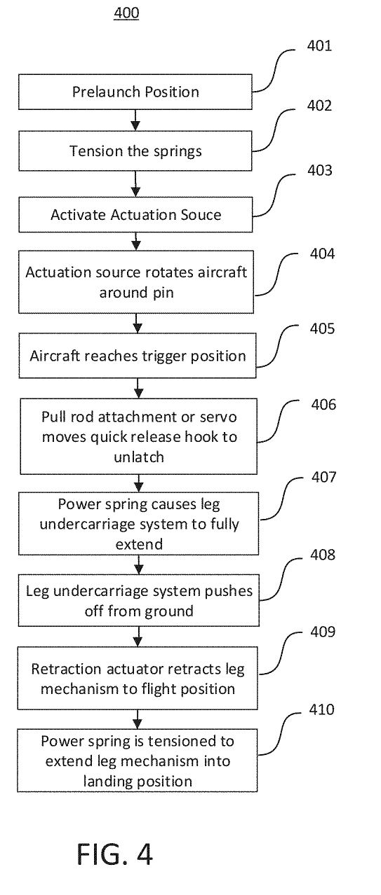

FIG. 4 is a flow chart of a method 400 that may be performed to transition between the five states of the leg undercarriage system. The leg undercarriage system starts in an initial prelaunch position (step 401). In this position, the leg is locked by the quick release mechanism.

Before launch, the power string is tensioned (step 402). An actuation source, such as aircraft motors, is activated (step 403). The actuation source propels the body of the aircraft and rotates the aircraft around pin 8 (step 404). When the aircraft rotates to a trigger position (step 405), the leg is released by the pull rod attachment or electrical servo moving the quick release hook to release from pin 8 (step 406). The power spring causes the leg undercarriage system to quickly move to the full extension position (step 407). This imparts velocity and altitude to the aircraft due to the push off of the toe from the ground (step 408).

When the aircraft has left the ground, the power spring is unloaded and the retraction spring, or an electrical servo, retracts the leg mechanism to the flight (retracted) position (step 409).

Before landing, the power spring is tensioned again, which extends the leg mechanism to the landing position (step 410). In the landing position, the leg acts as a spring and shock absorber for the landing loads.

In one variation, the power spring is a mechanical spring, and the retract spring is also a mechanical spring. Mechanical springs are effective for embodiments for use with low take-off weight aircraft. For heavier aircraft, the power spring may be an air spring, such as a pneumatic actuator, and the retract spring may also be an air spring, such as a pneumatic actuator.

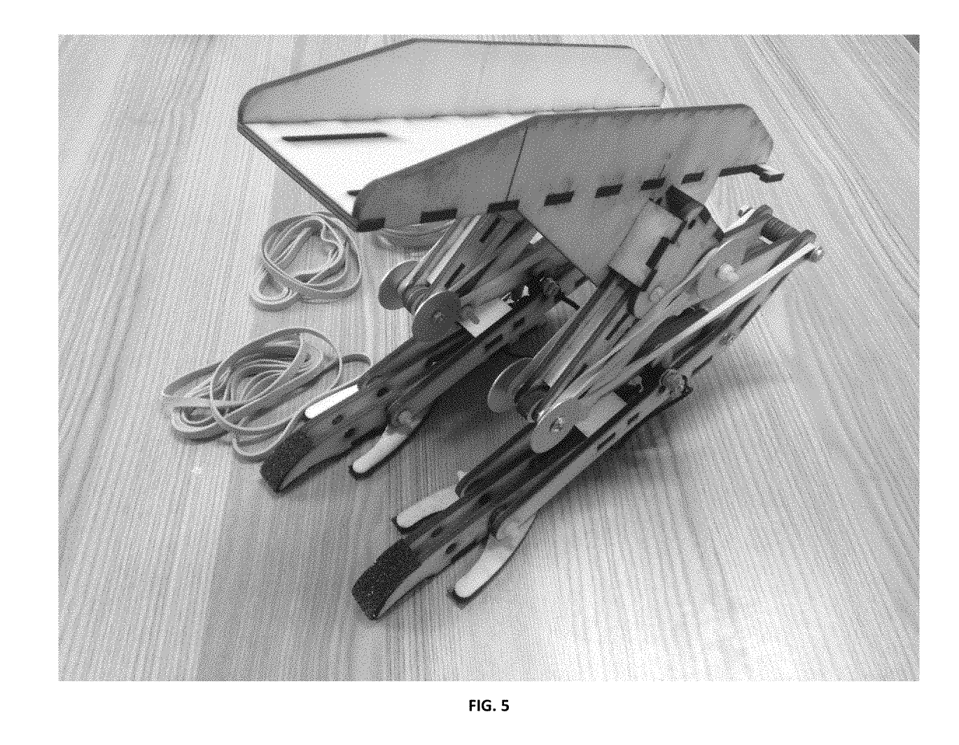

FIG. 5 shows a top perspective view photograph of the leg undercarriage system in the prelaunch position.

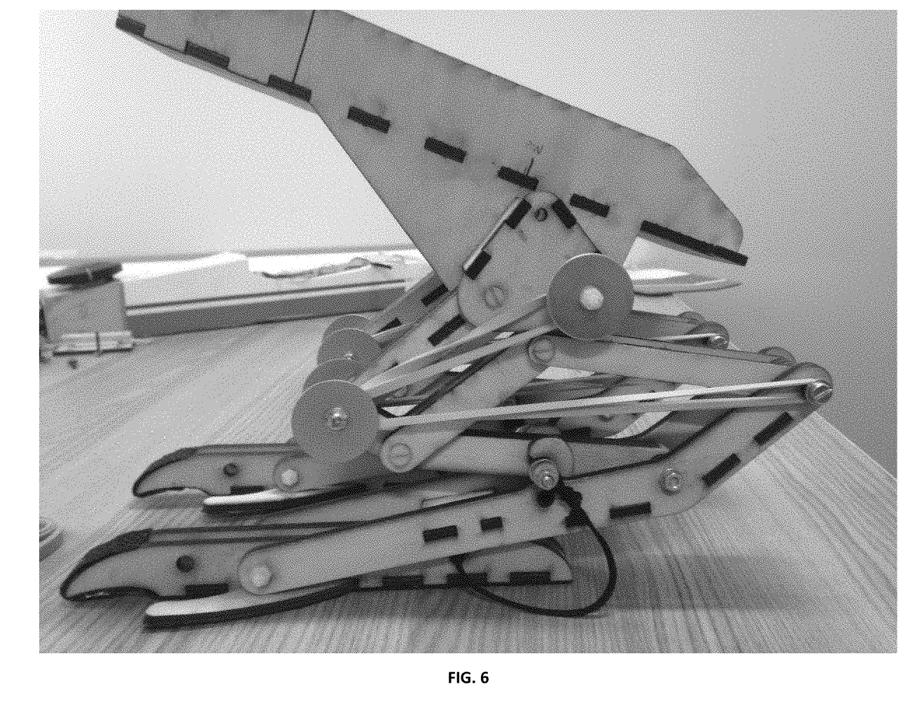

FIG. 6 shows a side view photograph of the leg undercarriage system in the prelaunch position.

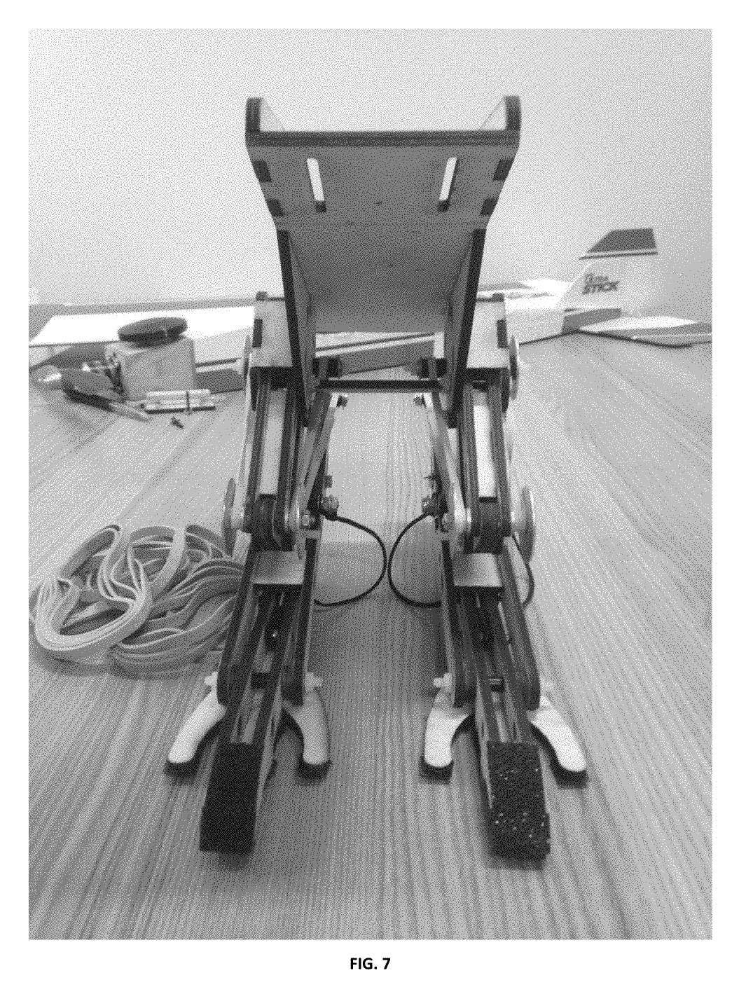

FIG. 7 shows a front view photograph of the leg undercarriage system in the prelaunch position.

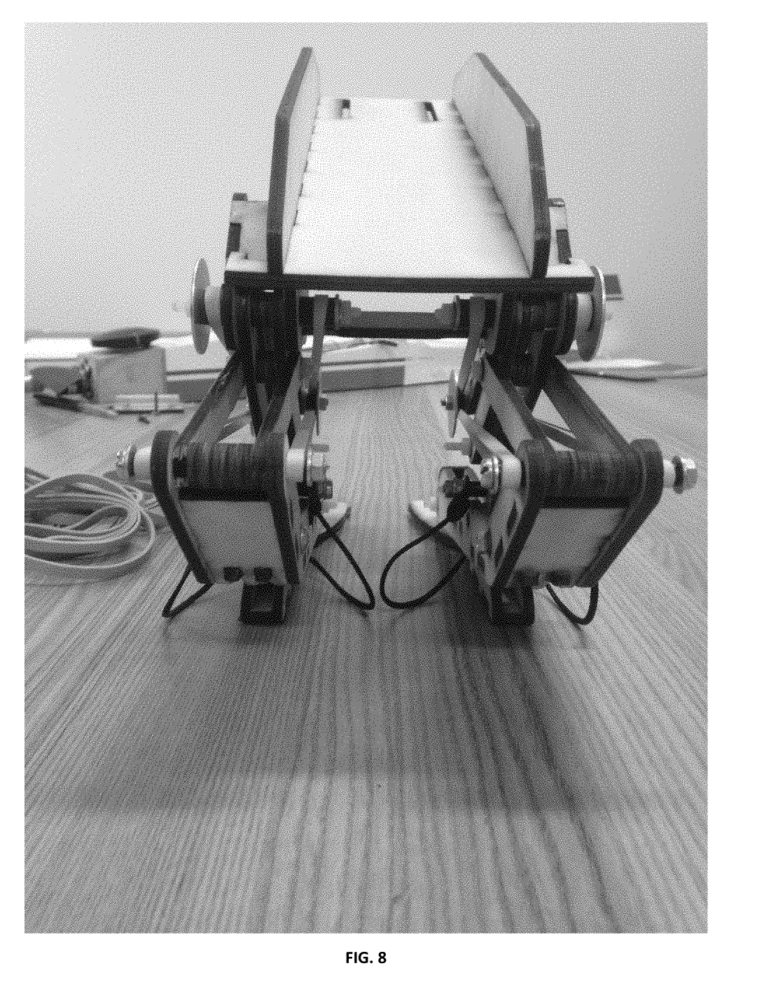

FIG. 8 shows a back view photograph of the leg undercarriage system in the prelaunch position.

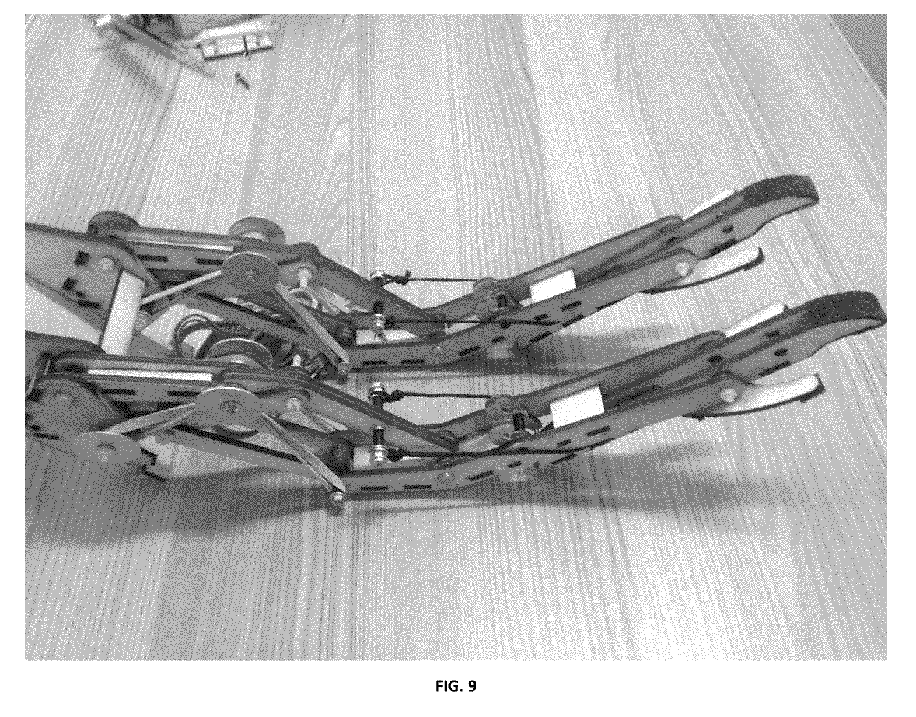

FIG. 9 shows a front view photograph of the leg undercarriage system in the fully extended position.

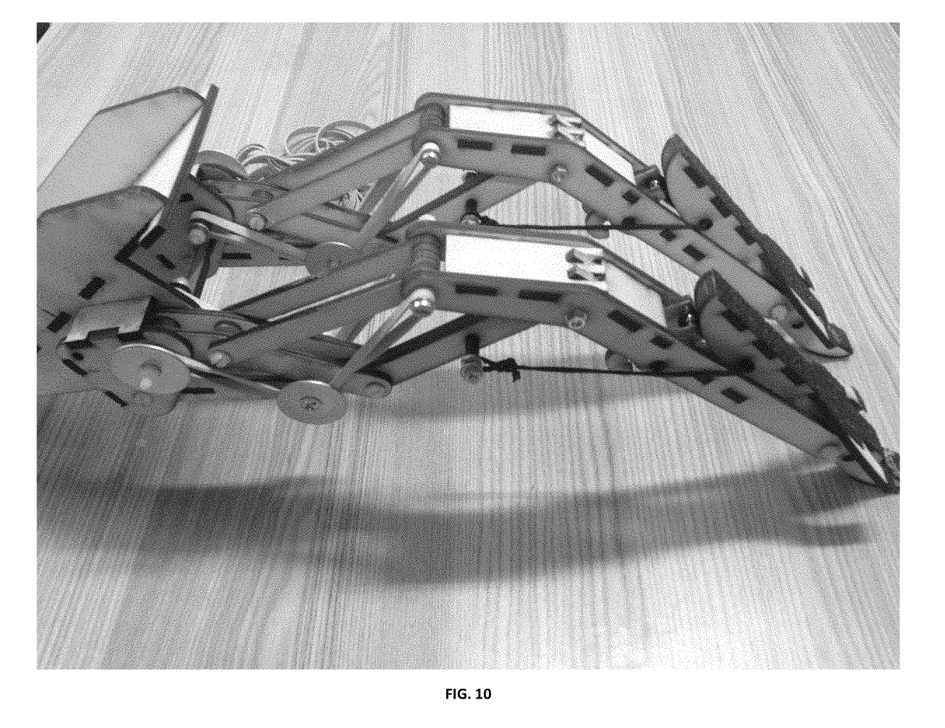

FIG. 10 shows a back view photograph of the leg undercarriage system in the fully extended position.

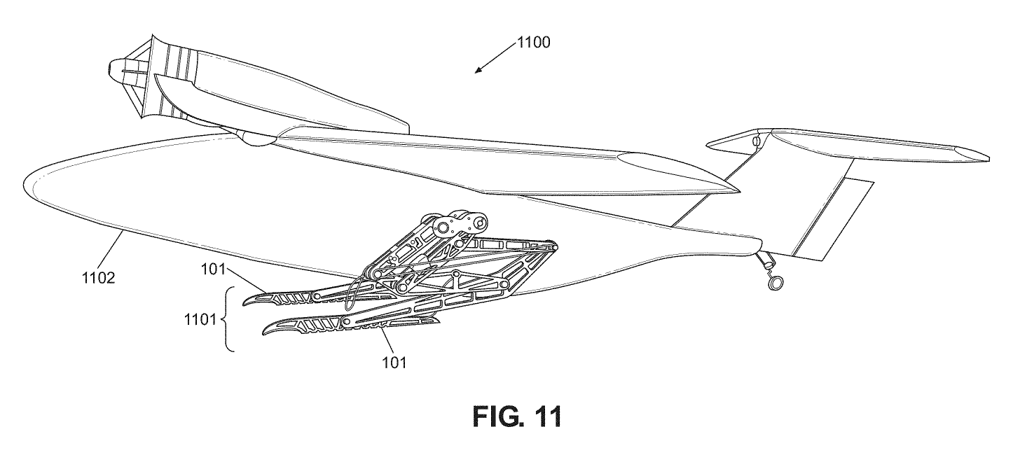

FIG. 11 shows the leg undercarriage 1101 with two legs 101 fitted to a fixed wing aircraft 1102 all together 1100.

Embodiments of the invention allow a fixed wing aircraft to perform take off from a stationary position by jumping in the air using propulsion from a leg undercarriage system. Therefore, embodiments of the invention include fixed wing aircraft with no wheels and that take off without rolling. Moreover, embodiments of the invention include fixed wing aircraft with no wheels and that land in a spot landing without rolling. The design of the leg undercarriage system makes wheels unnecessary for takeoff and landing. Moreover, the design of the leg undercarriage system makes use of a runway unnecessary for takeoff and landing.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

While various embodiments of a leg undercarriage system constructed according to the principles disclosed herein, as well as specific components of the leg undercarriage system, have been described above, it should be understood that they have been presented by way of example only, and not limitation. Thus, the breadth and scope of the invention should not be limited by any of the above-described exemplary embodiments, but should be defined only in accordance with the following claims and their equivalents.

What is claimed:

1. A method of enabling takeoff of an aircraft from a stationary position, the method comprising:
latching a quick release hook to an attachment member to hold a leg undercarriage system of the aircraft in a prelaunch position;
tensioning a power spring of the leg undercarriage system;
activating a motor of the aircraft;
rotating, by the motor, the aircraft to a trigger position;
when the aircraft reaches the trigger position, the quick release hook unlatching from the attachment member;
the leg undercarriage system extending to a fully extended position and imparting velocity to the aircraft.

2. The method of claim 1, further comprising:
a retract spring retracting the leg undercarriage from the fully extended position to a retracted position.

3. The method of claim 1, further comprising:
a pull rod attachment moving the quick release hook when the aircraft reaches the trigger position.

4. The method of claim 1, further comprising:
an electrical servo releasing the quick release hook when the aircraft reaches the trigger position.

5. The method of claim 1, further comprising:
extending the leg undercarriage system to a landing position.

6. The method of claim 1, wherein the power spring is an elastic member.

7. The method of claim 6, wherein the power spring is an air spring.

8. The method of claim 1, further comprising:
the leg undercarriage system extending to the fully extended position by rotating one or more leg links of the leg undercarriage system around one or more joints.

9. The method of claim 1, further comprising:
tensioning a retract spring.

10. The method of claim 1, wherein the rotation of the aircraft by the motor occurs around a joint in a toe of the leg undercarriage system.

11. The method of claim 1, further comprising:
rotating a third section of the leg undercarriage system around a first joint;
rotating a second section of the leg undercarriage system around a second joint;
rotating a first section of the leg undercarriage system around a third joint.

12. A leg undercarriage system for an aircraft, the leg undercarriage system comprising:
a fuselage attachment;
at least one leg link in an upper stage of the leg undercarriage system;
at least one leg link in a lower stage of the leg undercarriage system;
a power spring in an energy storage state;
a quick release hook holding the leg undercarriage system in a compressed position;
an actuator for releasing the quick release hook to extend the leg undercarriage system.

13. The leg undercarriage system of claim 12, wherein the actuator is an electrical servo.

14. The leg undercarriage system of claim 12, further comprising:
a leg link connected to the quick release hook.

15. The leg undercarriage system of claim 12, further comprising:
a retract spring.

16. The leg undercarriage system of claim 12, further comprising:
a tension member exerting a tension force.

17. The leg undercarriage system of claim 12, further comprising:
one or more pins joining the at least one leg link in the upper stage of the leg undercarriage system with the at least one leg link in the lower stage of the leg undercarriage system.

18. The leg undercarriage system of claim 12, further comprising:
a toe designed to grip the ground.

19. The leg undercarriage system of claim 12, further comprising:
a second leg link in the upper stage of the leg undercarriage system.

20. The leg undercarriage system of claim 12, further comprising:
a second leg link in the lower stage of the leg undercarriage system.

21. The leg undercarriage system of claim 12, further comprising:
wherein the power spring is an elastic member.

22. The leg undercarriage system of claim 12, further comprising:
wherein the power spring is an air spring.
